(19) United States
(12) Patent Application Publication
(10) Pub. No.: US 2016/0036574 A1
(43) Pub. Date: Feb. 4, 2016

(54) SYSTEMS AND METHODS FOR COMMUNICATING INTO A SHIELDED ENVIRONMENT

(71) Applicant: TUNNEL RADIO OF AMERICA, INC., Corvallis, OR (US)

(72) Inventor: Mark Rose, Albany, OR (US)

(21) Appl. No.: 14/813,991

(22) Filed: Jul. 30, 2015

Related U.S. Application Data
(60) Provisional application No. 62/031,744, filed on Jul. 31, 2014.

(51) Int. Cl. H04L 5/00; H04W 24/08; B61L 15/00; H04W 72/04

(52) U.S. Cl. CPC H04L 5/0048; H04W 72/04; H04W 24/08; B61L 15/0018

(57) ABSTRACT

A system and method for wirelessly communicating into a shielded area are described. In one particular example, a bi-directional amplifier that allows two-way communication into a tunnel is mounted at a tunnel portal and thereby allows RF signals to be exchanged therefrom using a single switched pathway. Ultrafast switching of the amplifier circuit is enabled by a pilot activation signal that serves to remotely switch the operational state of the amplifier from a default first operating mode when no pilot signal is detected to a second operating mode upon detection of the pilot signal, whereby the system is configured for simplex and semi-duplex communications.

### CROSS-REFERENCE TO RELATED APPLICATIONS

The present application claims priority to U.S. Provisional Patent Application No. 62/031,744 entitled “SYSTEMS AND METHODS FOR COMMUNICATING INTO A SHIELDED ENVIRONMENT,” filed on Jul. 31, 2014, the entire contents of which are hereby incorporated by reference for all purposes.

### FIELD

The present description relates to a radio communication system and method for communicating into a tunnel. The system and method may be particularly useful for a positive control system used by trains during transit.

### BACKGROUND AND SUMMARY

Recently, mandates were enacted to install positive train control (PTC) technologies throughout the railroad industry by 2015. PTC is a system of functional requirements for monitoring and controlling train movements as a train navigates the railway network that provides for increased safety in order to protect operating crews, railway workers, and passengers using the railway system. PTC generally involves integrating dynamic information from localized environments to ensure trains remain separated, which thereby avoids collisions from occurring, and is known to one skilled in the art as collision avoidance. PTC involves two components: the control unit on-board a lead locomotive and methods to dynamically inform the control unit of changing track or signal conditions. As such, PTC systems rely on on-board computers, extensive data bases, radio systems distributed along the rail lines, and centralized software methodologies that operate in synchronous communication during transit.

One place where communication along a rail line is particularly difficult is in a tunnel environment where radio signals are shielded from reaching mobile devices located therein. As such, RF signals are not reliably transmitted thereto and shielded areas thus represent dark territories within the railway network that are a source of potential danger. However, systems for transmitting RF signals into a tunnel environment are known.

One example to address radio communications into a tunnel environment includes a system using a leaky communication system that includes two amplifier boxes for boosting radio signals into and out of the tunnel environment at different radio frequencies. The two amplifier boxes further include uni-directional amplifiers connected to radiating wires such that each wire operates at a different frequency in order to enable duplex communication between a mobile device within the tunnel and a base station located remotely from the tunnel. Thus, communication is provided in both directions, along multiple pathways.

However, the inventors have recognized potential issues with such systems. Communication on a simplex channel, information only being provided in one direction, is difficult. Moreover, because the railroad industry uses simplex communication for sending control signals to trains navigating within the system, the addition of amplifiers and additional communication pathways increases the cost of implementing and maintaining the radio communication system compared to a system having one wire and one amplifier box.

One potential approach as found by the inventors to at least partially address the above identified issues is a bi-directional radio frequency communications systems for transmitting signals into a tunnel along a single pathway. The disclosed systems and methods for a RF communication system may therefore be operated in a simplex or half-duplex mode that is configured to allow ultrafast switching between the two operational modes. The system according to the present disclosure may be integrated and used seamlessly within the operating guidelines already in place throughout the railway industry.

In one example, the bi-directional radio frequency communication system may be used for remotely communicating with mobile devices in a shielded environment. Although the shielded area described herein is a tunnel within the railway network, other types of shielded environment are possible (e.g. a mine, the basement of a building, etc.). In addition, because the bi-directional amplifier described provides for ultrafast switching between operating modes using a pilot activation signal, signal loss during transmission is further prevented since the data (or voice) signals sent may be timed to begin after the bi-directional amplifier circuit has been switched.

The above advantages and other advantages, and features of the present description will be readily apparent from the following detailed description when taken alone or in connection with the accompanying drawings. It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic diagram of the communications system of the present disclosure.

FIGS. 2A and 2B show schematic diagrams of the communications system of FIG. 1 in the uplink receiving mode showing an example uplink path.

FIGS. 2C and 2D show schematic diagrams of the communications system of FIG. 1 in a downlink transmission mode showing an example downlink path.

FIG. 3A shows a schematic diagram of the communications device according to a first embodiment of the present disclosure.

FIG. 3B shows an example block diagram of the communications device of FIG. 3A.

FIGS. 3C and 3D show example LED interfaces to illustrate the switched state of the device.

FIG. 4 shows an example block diagram of a first embodiment of an exciter unit used in the communications system.

FIG. 5 shows a flow-chart illustrating one method by which a bi-directional amplifier switches between operational modes.

FIG. 6 shows a first example propagation diagram for extending a range of coverage beyond a tunnel environment according to the first embodiment.

FIG. 7 shows a second example propagation diagram for extending the range of coverage beyond the tunnel environment according to the first embodiment.

FIG. 8 shows a schematic diagram of the communications system according to a second embodiment of the present disclosure.

FIG. 9A shows an example block diagram of the communications system of FIG. 8.

FIG. 9B shows an block diagram of the communications device of FIG. 9A.

FIG. 9C shows an example block diagram of the OFA unit used in the communications system of FIG. 9A.

### DETAILED DESCRIPTION

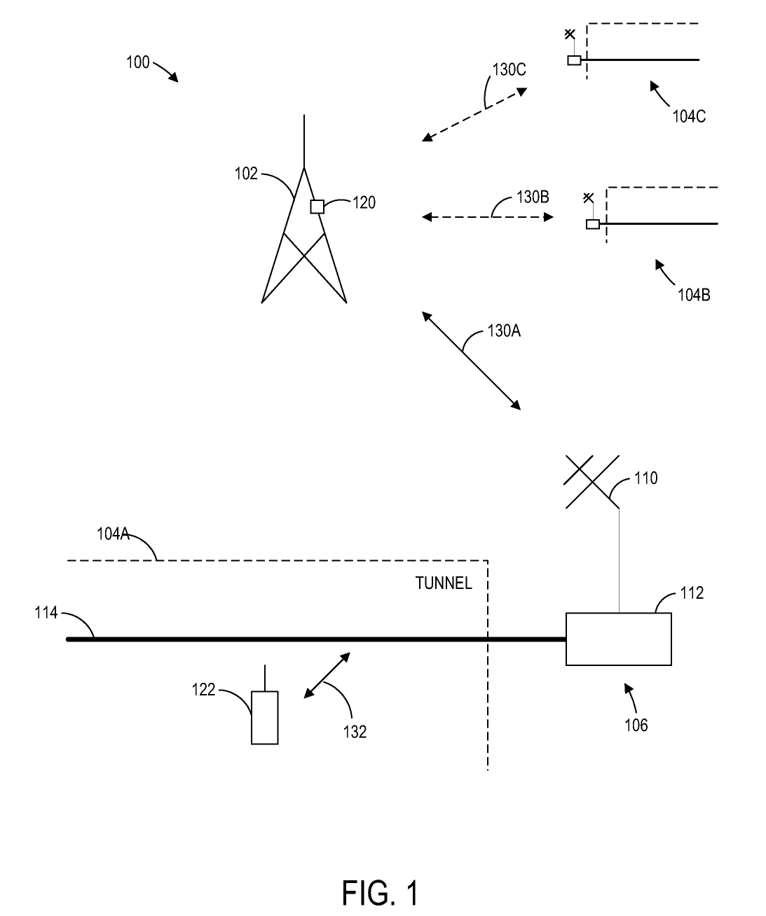

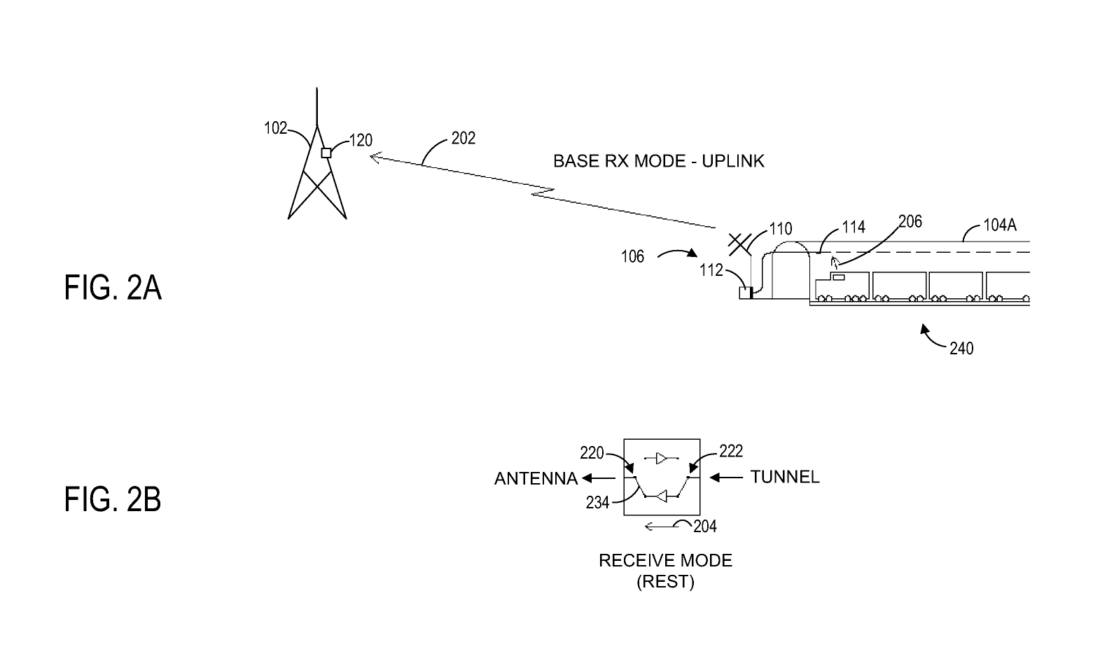

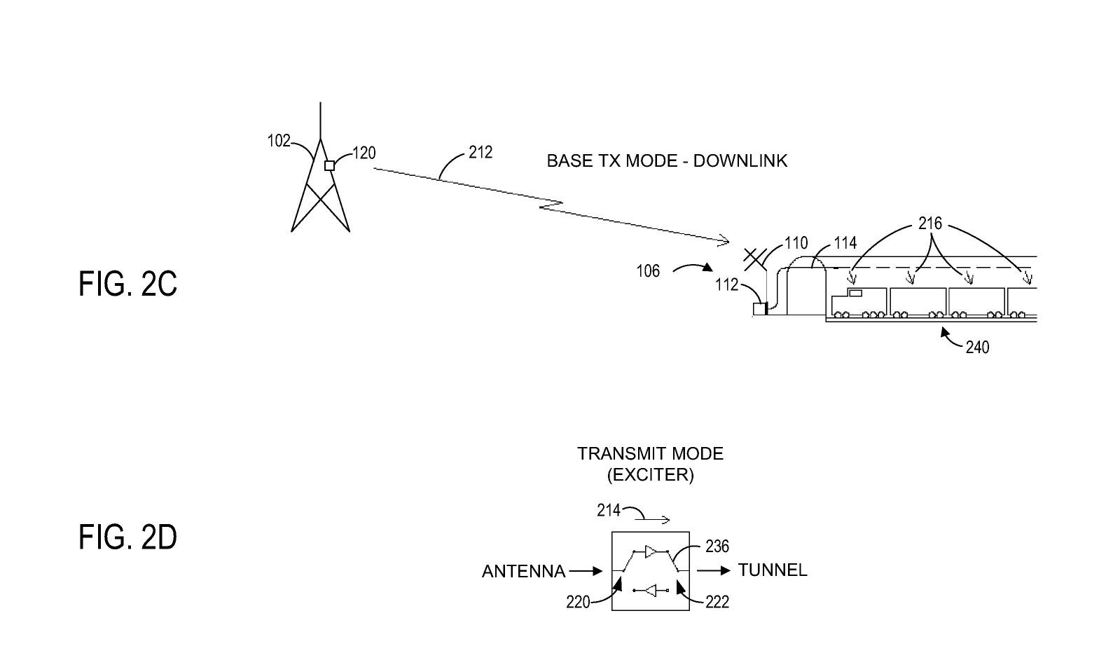

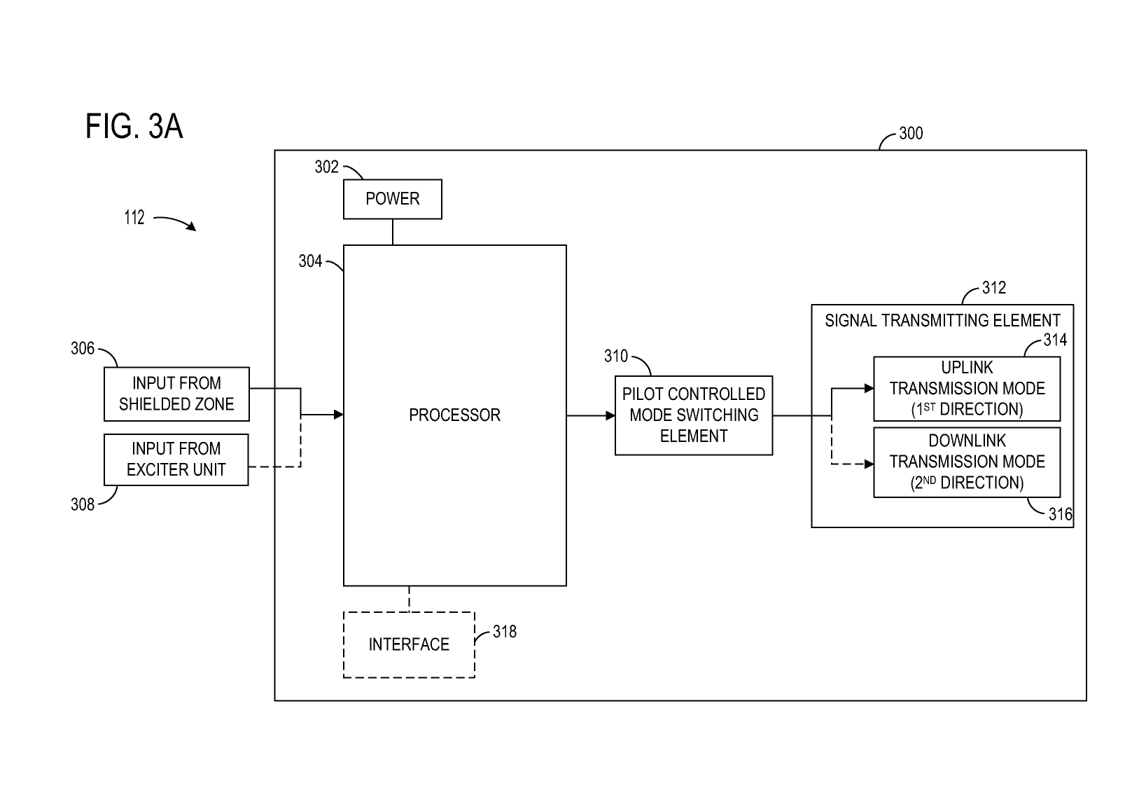

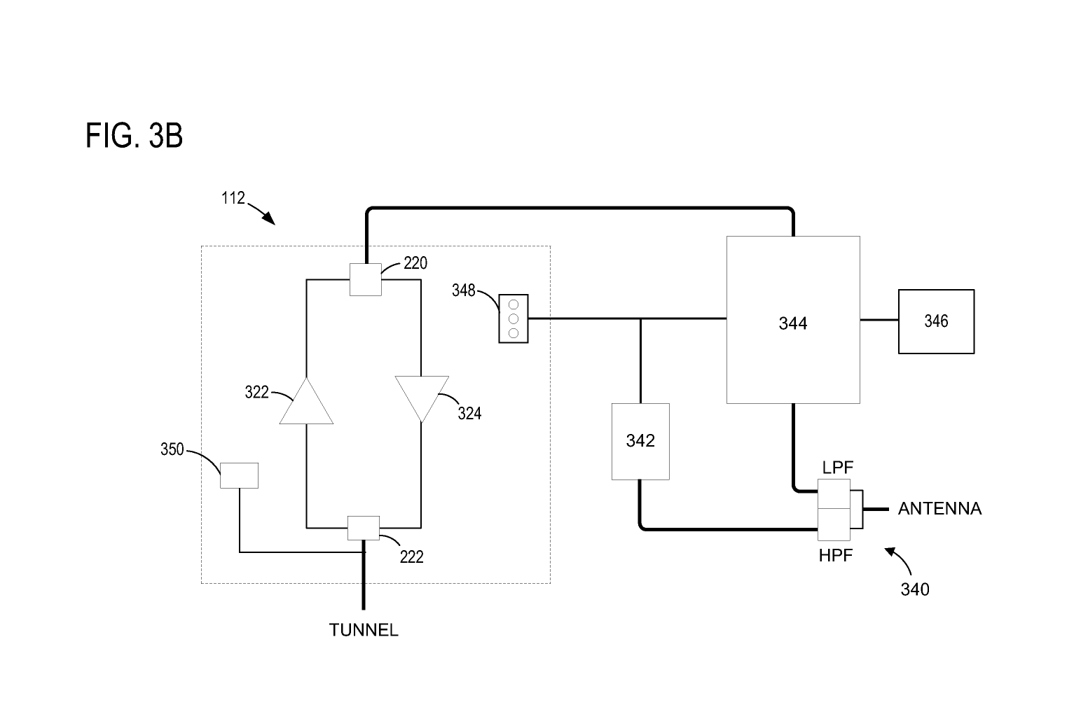

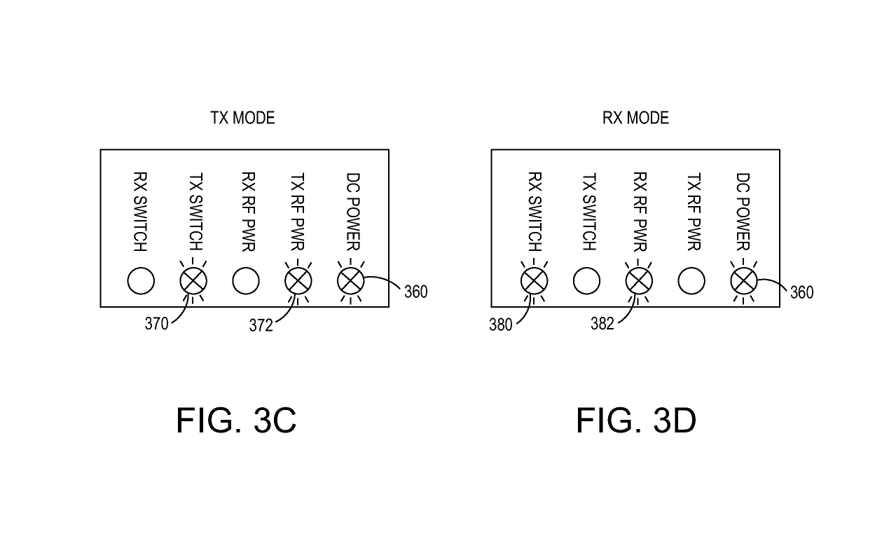

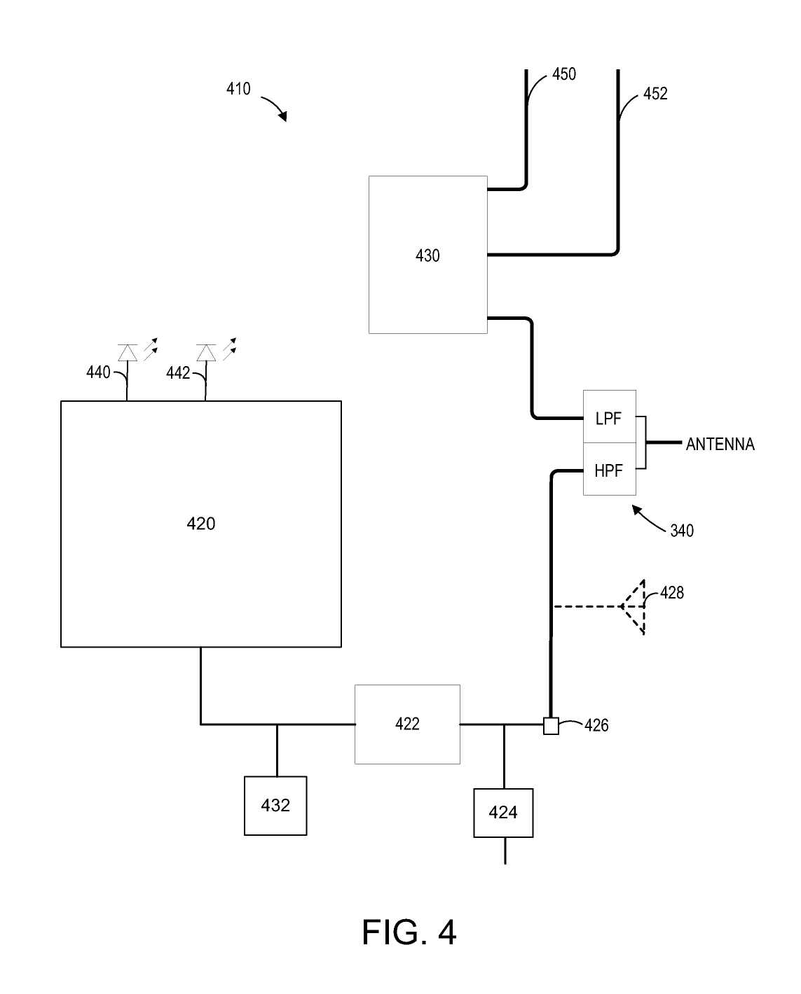

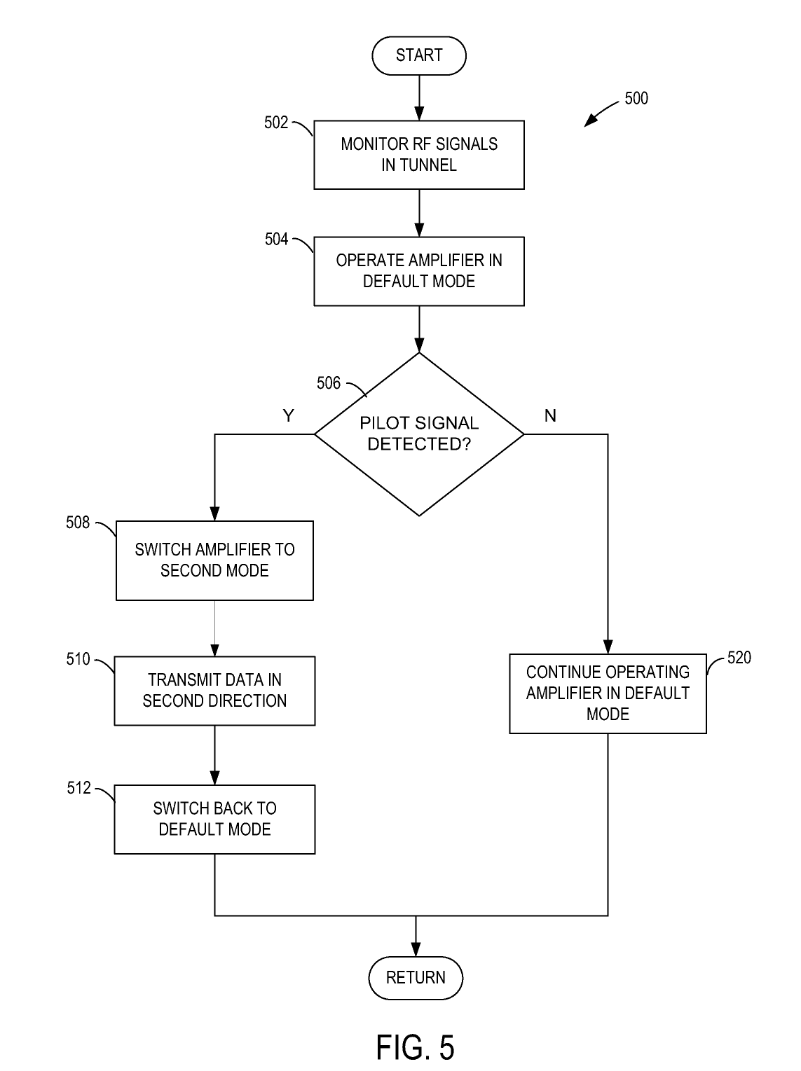

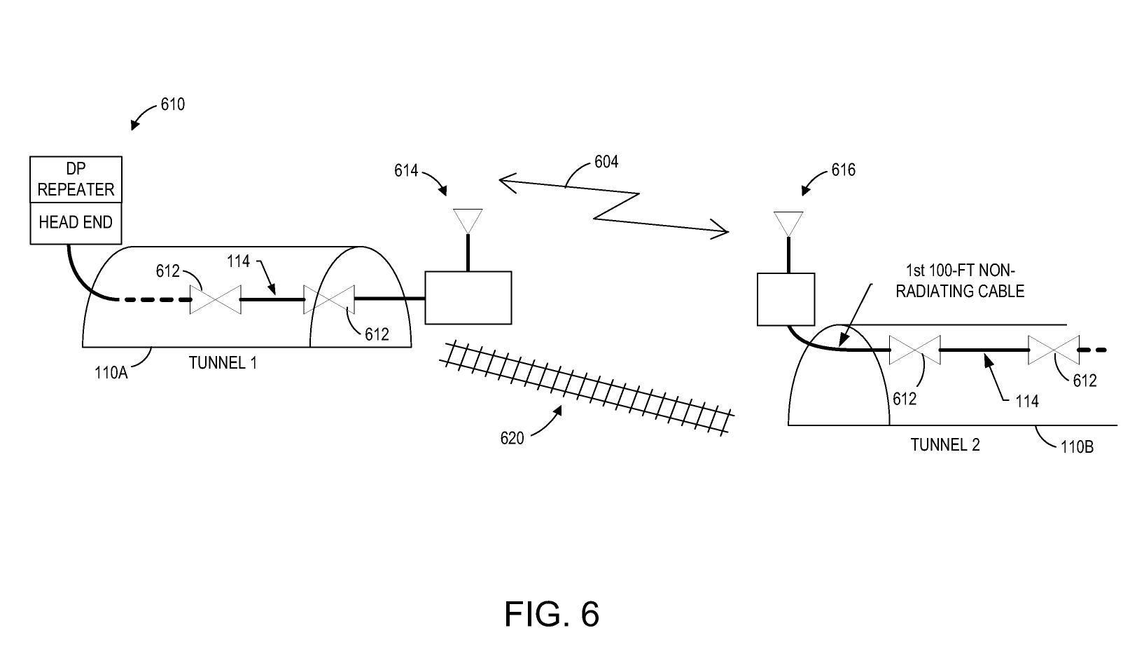

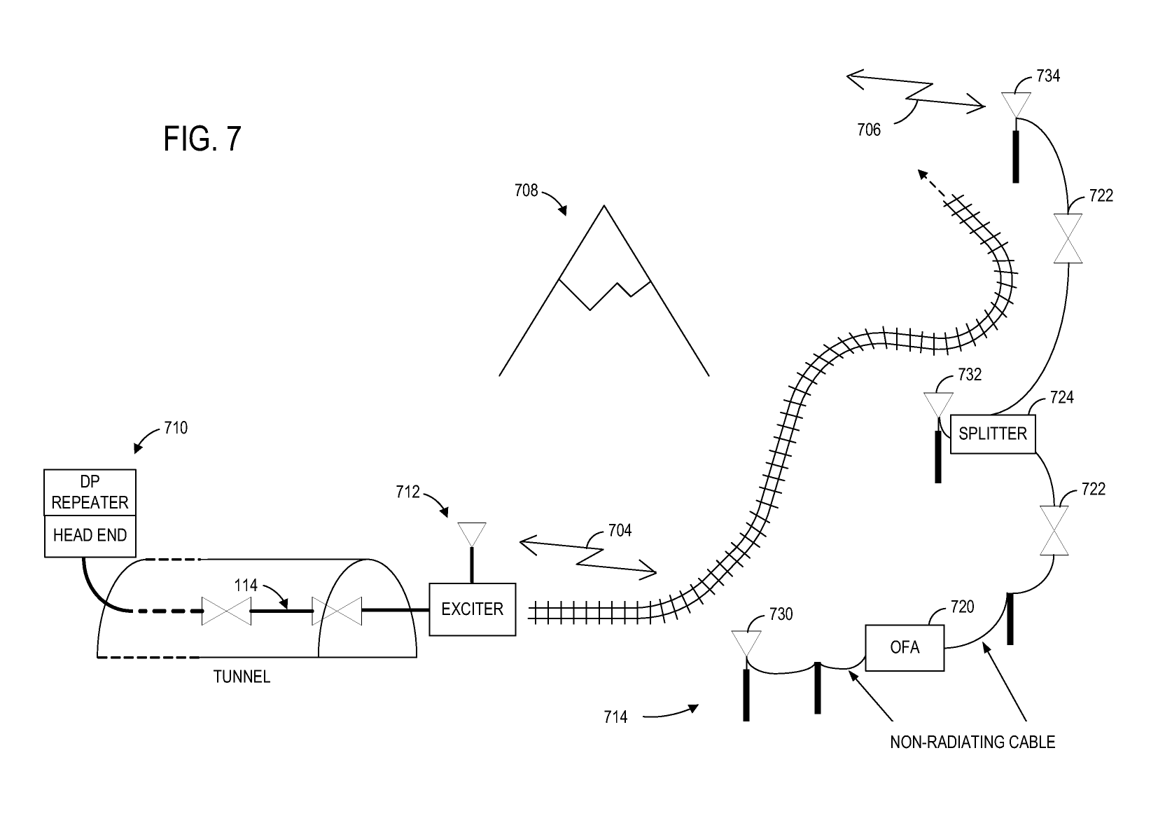

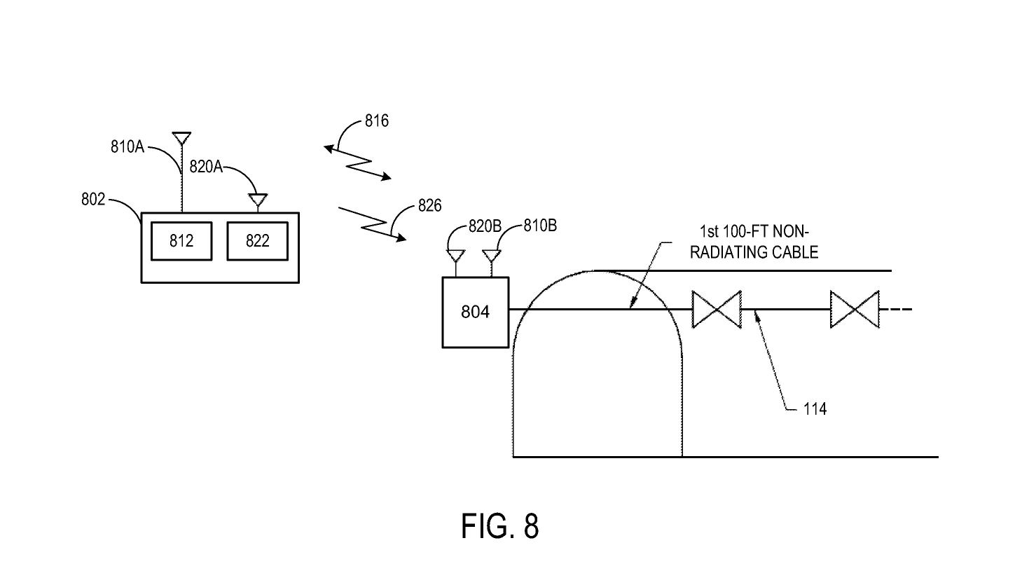

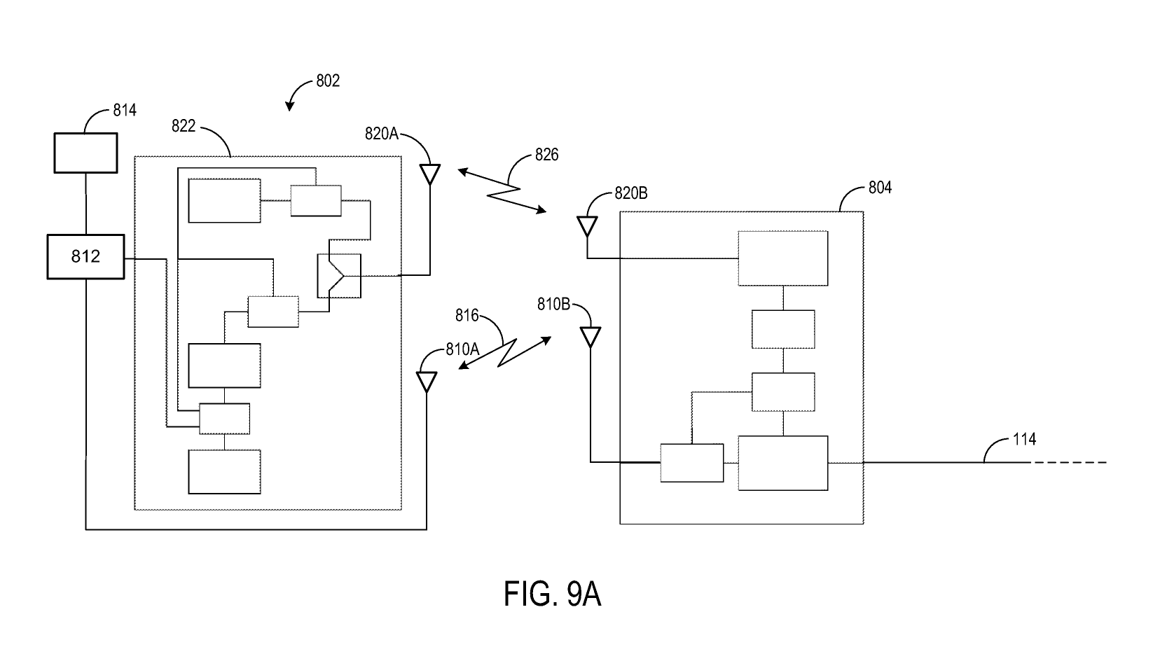

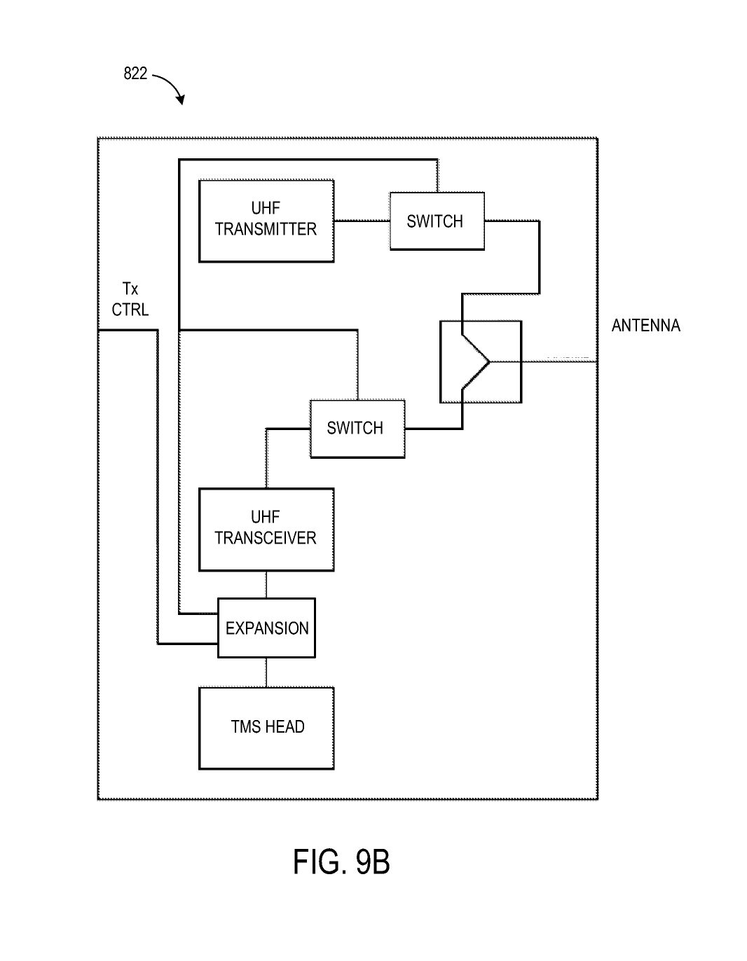

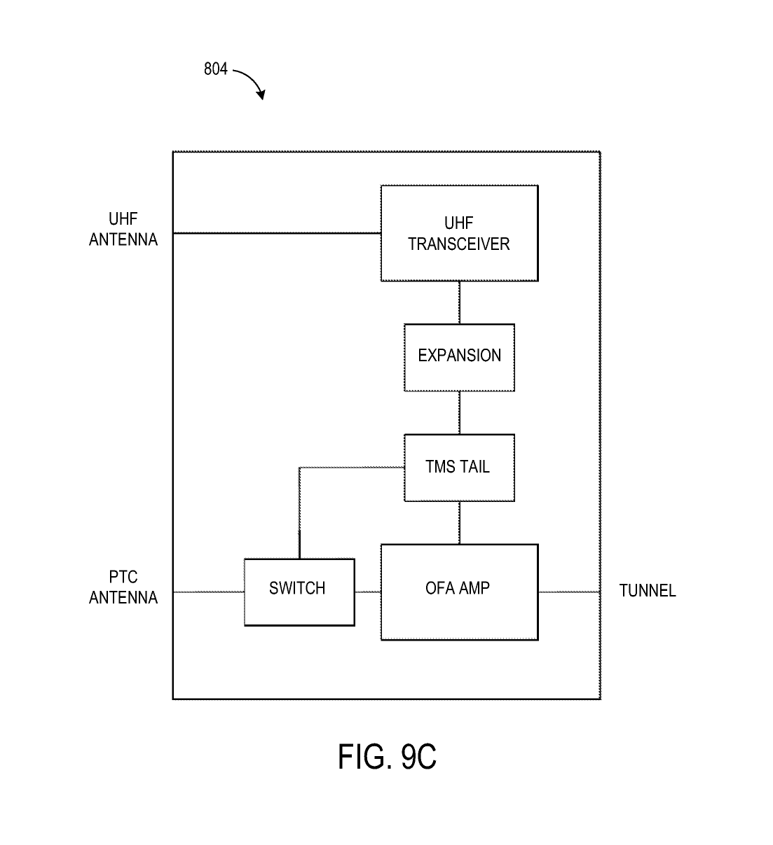

The present description is related to a device, system and method for communicating into a shielded area. For example, the RF communication system of the present disclosure may be used to improve communicating with a train navigating a tunnel. As such, FIG. 1 and FIGS. 2A-2D, and FIG. 8 are included to describe general features of the communication system in the environment of the tunnel. Then, because the RF system described uses a bi-directional amplifier controlled by a pilot activation signal received from a second transmitting device, FIGS. 3A-3D and FIG. 4 show example schematic diagrams of electronic hardware components in each device according to a first embodiment. In FIG. 5, a flow-chart is included to illustrate an example method by which the communications device is switched between operating modes. Furthermore, because signal propagation beyond the shielded tunnel environment may be quite difficult due to an isolated geography including a treacherous terrain, FIGS. 6 and 7 show example extension schemes and propagation diagrams whereby the range of coverage is extended beyond the tunnel environment. Finally, FIGS. 9A-9C shows example schematic diagrams of electronic hardware components included in each device according to a second embodiment.

Referring to FIG. 1, radio frequency communication system 100 includes a base station 102, and an antenna subsystem shown generally at 106 that is operable to receive and transmit RF signals into and out of tunnel 104A. Antenna subsystem 106 includes an antenna 110, a bi-directional off-air amplifier 112 (OFA) located beyond the portal of the tunnel, and a radiating coaxial cable 114, herein also referred to as a radiating transmission line, disposed along the length of the tunnel. Cable 114 is “leaky,” and allows the RF signals carried therealong to radiate therefrom for receiving by various receivers in the tunnel area. To promote RF leakage, cable 114 may include gaps, slots, or ribs to allow the radio signal to leak into or out of the cable along its entire length. Furthermore, because signal leakage is present and acts to reduce the strength of the transmitted signal, in some implementations, bi-directional line amplifiers may be inserted along the length of the cable to boost the signal transmitted, especially in longer tunnels where signals may be transmitted greater distances.

Base station 102 is in wireless communication with antenna subsystem 106 and may include equipment for tracking a train and transmitting data to communicate safe movements along the railway system to the train. Base station 102 may be further configured to communicate with a plurality of tunnels, identified specifically at 104A, 104B, and 104C. According to the methods of the present disclosure, an exciter unit 120 may be installed at the base station for generating a coded signal that provides for passive power distribution between the base station and one or more tunnel systems. As described in greater detail below, exciter unit 120 includes a fast attack time transmitter and may be configured for ultrafast switching of the system between transmit and receive modes via simplex or half-duplex communication methods. Herein, the transmit mode is a switched state of OFA 112 where the RF signal is transmitted in the direction from antenna 110 into tunnel 104A. Conversely, the receive mode refers to a switched state of OFA 112 where the RF signal is transmitted in the direction from the tunnel to the antenna. Therefore, since the system is bi-directional, OFA 112 may simply adjust the direction of signal transmission into or out of the tunnel environment over a single pathway.

With respect to the RF signals transmitted, FIG. 1 generally depicts two communication links. The first communication link 130 (e.g., directed to a first tunnel at 130A) comprises a bi-directional wireless link between base station 102 and antenna subsystem 106. As such, both devices may be configured to transmit and receive signals in open space. The second communication link 132 shown within tunnel 104A is also a bi-directional link, but couples antenna subsystem 106 and a mobile communication device 122. In one implementation, the mobile communication device may be a head-of-train (HOT) device located in the lead locomotive of a train and operable for sending status signals to base station 102. Because prescribed frequencies are used throughout the railroad industry, base station 102 and antenna subsystem 106 may be configured to operate at a number of frequencies identified as: F1: 452.925 MHz; F2: 452.950 MHz; F3: 457.925 MHz; and F4: 457.950 MHz. In other examples, the radio communication system according to the present disclosure may alternatively or additionally be designed to operate in other frequency bands (e.g., 150-170 MHz, 220 MHz, and 400-500 MHz) and multiple channels may be used within the band set on each system. It is foreseeable that still other frequencies may be used in the future. In another implementation, to feed multiple bands into a tunnel or shielded area, multiple radio communication systems may be used. However, in still other implementations, multiple bands may be fed into a shielded area by including additional electrical components (e.g., a second antenna) within each device. Without the communication system of the present disclosure, when a train is in the tunnel environment, the RF signal from base station 102 is blocked or shielded from reaching mobile communication device 122.

Thus, a communication system, comprising a transmission device for wirelessly sending RF signals into one or more shielded areas via a bi-directional amplifier coupled to a radiating transmission line is provided. A bi-directional amplifier may be configured to transmit RF signals in two directions over a single pathway based on detection of a wireless pilot activation signal received from the transmission device. The radiating transmission line coupled to the bi-directional amplifier is disposed along the length of the shielded area.

In one embodiment, the transmission device is located at one of: a base station on a first tunnel side, a distributed power repeater on a first tunnel side, and a second tunnel side opposite the distributed power repeater.

In one embodiment, the bi-directional amplifier includes a processor for transmitting RF signals in two directions along a single pathway, and a pilot controlled switching element for switching the bi-directional amplifier between two operating modes within a threshold time period, the threshold time period further being 1 millisecond.

In one embodiment, the two operating modes include an uplink transmission mode that transmits RF signals from the shielded area to the transmission device, and a downlink transmission mode that transmits RF signals from the transmission device to the shielded area. In one example, the uplink transmission mode is the default mode. The default mode may operate when no pilot activation signal is received from the transmission device.

In one embodiment, a transmission device is located at a second tunnel side to communicate beyond a tunnel into a second shielded area by exchanging signals with a bi-directional amplifier coupled thereto.

The communication system may wirelessly communicate beyond the shielded area. Communicating beyond the shielded area may include transmitting signals via an antenna network.

Thus, a communication system is provided which can communicate into a shielded area via two operating modes. Additionally, the communication system may wirelessly communicate with areas beyond the shielded area.

Turning now to FIGS. 2A-2D, a first embodiment of the bi-directional switching of OFA 112 is described in greater detail. Therein, schematic diagrams of the communications system of FIG. 1 are shown in the uplink receiving mode (RX) and downlink transmission mode (TX). In the first embodiment, which may apply to a positive train control system for communicating with a train navigating a tunnel along a railroad track, OFA 112, mounted near or at the tunnel portal, incorporates one or more antenna switches whose position is determined based on a control signal from exciter unit 120 located at base station 102. Thus, the remote OFA device, for example OFA 112 previously illustrated, may be switched wirelessly via a securely encoded pilot signal generated from the base station that provides the logic for switching the OFA device between receive and transmit modes.

In one example, the bi-directional amplifier may operate in an uplink mode, herein also referred to as the rest condition and/or the receive mode. When operating in this mode, signal flows from inside the tunnel to the antenna subsystem and further to the outside environment (e.g., outside free air space) where exciter unit 120 is located. Although the exciter unit 120 is described as located at base station 102, other locations are possible and have been contemplated. For example, in another implementation, exciter unit 120 may wirelessly direct OFA 112 from a distributed power (DP) repeater site. In the at rest condition, a mobile wireless unit within the tunnel may transmit signals over the air using wireless communication methods while navigating the shielded tunnel. For instance, a signal transmitted by a mobile wireless device, e.g., mobile communication device 122, may be captured and carried by a leaky coax cable or antenna to an amplifier OFA including a signal booster oriented to amplify 220 Mhz signals (and other bands). In this way, the OFA signal booster may amplify captured signals to a usable level while overcoming coax and/or airspace losses. For this reason, multiple units may be included and oriented longitudinally along the length of the tunnel, particularly in longer tunnels where cumulative signal losses are greater. The signal transmitted is thus increased by the signal booster to a level high enough to overcome pathway and/or free space losses, which allows connectivity to a remotely located fixed station for reception. The fixed station may receive captured mobile data or voice signals that are then converted by the fixed station and carried to one or more servers at a remotely located dispatch center (e.g., by a company network). According to the present disclosure, the radio frequency communications system is operable to pass either voice or data signals.

However, the system also provides for automatic pathway switching to a downlink mode that allows signal passage into the tunnel environment. For this reason, a server or dispatch unit may also be included in some embodiments to initiate a transmission command to a connected wireless fixed station to poll a mobile device. In this way, a connected fixed station may transmit a radio signal over air to an OFA signal booster mounted near a remote facility like a tunnel entrance. For example, a pilot channel signal may be transmitted in parallel and simultaneously with another desired channel configured to carry data using an independent transmitter linked to the fixed base station. The function of the pilot signal is to control OFA booster directivity by allowing for ultrafast switching of the direction of signal propagation. Thus, upon receipt of an appropriate 60 MHz pilot activation signal, the direction of signal propagation may be adjusted. However, this frequency is non-limiting and in another example, the pilot activation signal may have a different frequency, e.g., 468 MHz. When no pilot signal is detected, the amplifier operates in a default at rest position. In the downlink mode, activated circuitry in the OFA signal booster may be adjusted by virtue of the presence of the pilot signal. As described above, the signal transmitted may then be boosted to a usable level, and passed to a local antenna and/or leaky coax cable extending along the tunnel or other shielded structure. Thereafter, one or more mobile units may receive the desired signal transmitted over the air wirelessly. Upon completion of the transmission sequence from the fixed station, the pilot signal may be turned off, which returns the OFA signal booster to the rest condition during operation.

Continuing with a description of the communication system, FIGS. 2A-2D schematically illustrates a train in a tunnel communicating with base station 102. With respect to the uplink RX mode of FIGS. 2A and 2B, while train 240 navigates the tunnel, RF signals represented by arrow 206 are emitted from the lead locomotive of the train and transmitted through radiating cable 114 toward antenna subsystem 106. As such, the OFA signal booster and hardware is operated in the receive mode or rest condition wherein the flow of electronic signal through OFA 112 is shown by arrow 204 and the signal transmitted is further propagated into the open air space beyond the antenna subsystem where the base station may receive uplink signal 202. Therefore, the position of switch 220 and switch 222 within OFA 112 may be adjusted to operate the bi-directional amplifier in an uplink pathway 234. When OFA 112 operates in this mode and a signal is received from the locomotive of the train, the signal may be wirelessly communicated to base station 102 as shown.

According to the first embodiment, the radio frequency communication system of the present disclosure may be operated in either a simplex or half-duplex mode by transmitting RF signals in one direction at a time. However, the system may be configured to operate at a number of frequencies using multiple channels within the band set on each system. For instance, when operating in a simplex mode, communication may occur in one direction, e.g., from train 240 to base station 102, as shown in FIG. 2A. Alternatively, depending on the presence of a pilot signal, the communications system may also operate in the half-duplex mode, which provides communication in both directions, but only one direction at a time. As such, communication in both directions is prevented from occurring simultaneously. In the half-duplex mode, once a party begins receiving a signal, that party generally waits for the transmitter to stop transmitting before a reply can be sent back along the same pathway.

In the downlink TX mode shown in FIGS. 2C and 2D, base station 102 sends a downlink signal 212 that includes a pilot activation signal that switches the direction of signal propagation through the bi-directional amplifier. As described above, the pilot signal functions to switch the operating state of the amplifier so RF signals are transmitted into tunnel 104A, as shown by arrow 214. Upon receiving the pilot signal, the positions of switch 220 and switch 222 are adjusted so the amplifier operates according to a downlink pathway 236, which completes the downlink circuit so the RF signal is transmitted into tunnel 104A. In some embodiments, the RF signal transmitted into tunnel 104A may be further received by mobile devices present therein, as indicated by arrows 216. In other embodiments, in positive train control, a lead locomotive typically handles substantially all communications.

Although the communication system described herein operates in a default rest condition with signal propagation in the uplink direction, implementations are possible where reversed signal initiation occurs. That is to say, an implementation is possible wherein the initiation sequence is reversed and the dispatch computer transmits a signal in the downlink direction first, and then a mobile unit within the tunnel responds using the uplink mode.

Thus, a radio frequency communication device, comprising: an antenna for sending and receiving RF signals, and a bi-directional amplifier configured to transmit RF signals over a single pathway, the RF signals transmitted at least partially through a shielded area, wherein the bi-directional amplifier unit comprises: a processor for adjusting a signal transmission direction based on detection of a pilot activation signal, a pilot controlled mode switching element for switching the device between two operating modes based on detection of the pilot activation signal, the two operating modes comprising: an uplink transmission mode wherein RF signals are transmitted in a first direction, wherein the uplink transmission mode is a default mode when the pilot activation signal is not detected, and a downlink transmission mode wherein RF signals are transmitted in a second direction.

The radio frequency communication device of claim 1, wherein the device includes one of: a steel case for enclosing one or more electrical components and a mounting rack for attaching one or more electrical components.

The radio frequency communication device of claim 1, wherein the device is coupled to a radiating transmission line to allow communication into the shielded area.

The radio frequency communication device of claim 3, wherein the device is coupled to a second transmitting device configured to send RF signals into the shielded area via the bi-directional amplifier.

The second transmitting device of claim 4, wherein the second transmitting device is further configured to transmit the pilot activation to switch operating modes of the radio frequency communication device.

The radio frequency communication device of claim 1, wherein RF signals in the first direction are transmitted from the shielded area to the second transmitting device, and wherein the device is switched to transmit RF signals in a second direction from the second transmitting device to the shielded area.

The radio frequency communication device of claim 6, wherein switching the device occurs within a threshold time period.

The radio frequency communication device of claim 7, wherein the threshold time period is 1 millisecond.

The radio frequency communication device of claim 3, wherein the shielded area is a tunnel.

Turning to the individual components within communications system 100, in FIGS. 3A-3C, the first embodiment of OFA 112 is described in greater detail. The schematic diagram of FIG. 3A shows that OFA 112 is a device with two operating modes for transmitting data and voice signals in two different directions. As such, the device, that contains a power supply 302 for delivering power to a processor 304, can transmit various RF signals as shown at 306 and 308. In the first embodiment, the signal transmitting element 312 is configured to operate in uplink transmission mode 314 by default wherein the shielded zone input 306 (e.g., electrical signal) is processed while transmitting RF signals in the first uplink direction. Then, according to the methods described, the pilot controlled mode switching element 310 is adjusted to switch the device into a downlink transmission mode 316 whereby exciter unit input 308 is received while transmitting RF signals in the second direction. Although not described herein, interfaces have been contemplated and therefore, in some implementations, OFA 112 may include interface 318 for viewing various data signals transmitted.

In one implementation, OFA 112 that is mounted at a tunnel entrance is housed within steel case 300 as shown in FIG. 3A. Although many materials and sizes are possible, steel case 300 may be a 16″×20″×6″ deep box made of steel NEMA 4 with flanges that encloses and protects the electrical components stored inside the steel cabinet in one example. To enable mounting at the site of the tunnel, steel case 300 may also have connectors coupled thereto. In another implementation, OFA 112 may be rack mounted at the tunnel entrance. With regard to the mounting, the OFA unit may be mounted to a vertical concrete wall in a location out of direct sunlight to prevent overheating. When OFA 112 is rack mounted, the function of the amplifier remains the same but the electrical components are mounted to a solid surface, for example, by attaching the components to a steel sheet instead of encasing within a steel case, but in a similar configuration and without the enclosure to protect the individual components.

In FIG. 3B, the electrical components of OFA 112 are schematically illustrated. Therein, the example block diagram shows that OFA 112 is comprised of a bi-directional amplifier that can operate in two modes to transmit radio signals out of and into a tunnel. To enable various features of the communication system described, the circuit also includes duplexer 340, receiver 342, tunnel monitoring system (TMS) module 344, and a power supply 346 that are now briefly described.

In radio communications, duplexer 340 is coupled to an antenna, for example the antenna 110 as illustrated in FIG. 1. The duplexer 340 is a device that allows bi-directional communication over a single path. Duplexer 340 is further comprised of low-pass filter (LPF) and high-pass filter (HPF) to allow a specific range of frequencies to pass through the device with a substantially minimum amount of interaction and degradation of the RF signals.

Receiver 342 is an electronic device that is used with the antenna to receive radio waves and convert the information carried therein to a usable form. The antenna intercepts radio (or electromagnetic) waves and converts them to an electrical current that is sent to the receiver. The receiver then extracts a desired set of information and passes the extracted signal through the circuit. In one example implementation, the antenna is a 4-bay dipole or Yagi with 9 dB of gain mounted near the unit with sufficient vertical height to operate line-of-sight from the exciter unit.

TMS module 344 provides for pinging amplifiers in the tunnel serviced by the OFA. Pinging amplifiers allows for the availability status of the amplifiers to be confirmed as a means of ensuring that the amplifiers remain operational during deployment. As such, TMS module 344 includes a head card that can ping amplifiers equipped with tail cards in the tunnel, which thereby allow for monitoring radio waves within the tunnel.

OFA 112 may include a power supply 346. In some implementations, power supply 346 may be a battery. Alternatively, or additionally, in other implementations, OFA 112 may include a connection to an external DC power supply. For example, OFA 112 may be connected to an externally-located power supply by a power cord (not shown). In one example, due to the low power requirements of the OFA unit, the externally-located power supply may be generated by a solar panel mounted on the face of the tunnel portal. For instance, a solar powered OFA unit may be supplied power by a 15 W solar panel.

As one example, bi-directional off-air amplifiers may operate at +11-16 volts DC at 300 mA in the RX mode and +11-16 volts DC at 200 mA in the TX mode. The amplifier provides an RF gain of +60 dB in each direction and has an “on” switching threshold of −90 dBm and an “off” switching threshold of −96 dBm. In the tunnel, ultra-high frequency (UHF) signals from the monitoring and control subsystems are normally blocked by the shielding effect of the tunnel walls, floor and roof, keeping the signals from reaching the receiving units. The active antenna system described herein keeps the transmitters and receivers in constant communication via a repeater in exciter unit 120. In this system, when a pilot activation signal is received at pilot control 350 and the system is in the receive mode, switches 220 and 222 reverse, thus allowing the carrier signal to transmit the bi-directional amplifier along the TX pathway 324 (with the pathway following the direction of the triangle head) while boosting the signal to +60 dB. However, when the unit is in the default rest mode, the signal path is through RX pathway 322, and the signal is amplified up to +60 dB. In some embodiments, the TX and RX pathways may include additional amplifiers indicated by triangle heads in the pathways shown.

Referring to FIGS. 3C and 3D, example LED lighting patterns are shown for both the TX and RX modes. Therein, LED 360 illuminates to indicate that the amplifier unit is turned on and receiving DC power. Then, when the unit is receiving enough power to perform the operations as designed, two different sets of lights may alternately illuminate along with LED 360 based on the operating mode of signal transmission. For instance, LEDs for TX switch 370 and RX switch 380 may be lit when the respective signal pathway is powered. Then, in addition, LED lights may be present whose illumination in each signal transmission mode indicates a power output that exceeds a pre-determined threshold. Inclusion of these LED lights allow for a determination to be made that the unit is not functioning as designed. For instance, in the TX mode shown in FIG. 3C, the TX RF PWR LED 372 may be illuminated when the TX RF output power exceeds a first threshold, e.g., +18 dBm. Alternatively, as FIG. 3D shows, the RX RF PWR LED 382 may be illuminated when the RX RF output power exceeds a second threshold, e.g., +12 dBm.

In FIG. 4, an example block diagram of exciter unit 120 is described in greater detail. As described above, in the first embodiment, the exciter unit 120, also referred to as a head end, may be installed at the site of a fixed base station 102 in communication with OFA 112. Exciter unit 120 includes internal components 410 for generating a pilot signal that is used to switch transmission modes of the amplifier unit and provides for passive power distribution between the repeater, tunnel system, and antenna. However, as will be described in detail below, in other implementations, exciter unit 120 may also be installed at the site of a DP repeater, which is an electronic device for receiving a signal and retransmitting the signal at a higher power. DP repeaters are often used to transmit signals onto the other side of an obstruction so a particular signal can be made to cover longer distances.

Exciter unit 120 includes duplexer 340 in contact with antenna, e.g., antenna 110. As described above with respect to OFA 112, duplexer 340 is further comprised of a low-pass filter (LPF) and a high-pass filter (HPF) to allow a specific range of frequencies to pass through the device with a substantially minimum amount of interaction and degradation of the RF signals. Although the antenna is shown coupled to duplexer 340, in other embodiments, a second antenna 428 may be included for transmitting or detecting multiple signals.

To accommodate bi-directional communication, exciter unit 120 may further include hardware interrupt 426, which is a device that can send an asynchronous electronic alerting signal to the transmitter from an external device in the middle of instruction execution. Transmitter 422 is an electronic device which, with the aid of an antenna, produces radio waves. The transmitter itself generates a radio frequency alternating current, which is applied to the antenna. When excited by this alternating current, the antenna radiates radio waves consistent with the signal produced. Attenuator 424 is included to reduce the power of a signal without appreciably distorting the signal waveform. Thereby, the unit may use less power during operation.

Printed circuit assembly, or PCA 420, is simply a board used to mechanically support and electrically connect electronic components using conductive pathways, tracks or signal traces etched from, for example, copper sheets laminated onto a non-conductive substrate. PCA 420 includes two LED lights shown at 440 and 442. First exciter LED 440 is included to indicate the unit is operating in the TX mode while second exciter LED 442 indicates that the unit is on and receiving sufficient power during operation.

As described above with respect to OFA 112, power supply 432 may be a battery in some implementations. In another embodiment, with respect to OFA 112, a connection to an external DC power supply may be included alternatively or in addition to a battery. For example, the unit may be connected to an externally-located power supply by a power cord, and due to the low power requirements of the unit, the externally-located power supply may be generated by a solar panel mounted in close proximity to the unit.

The power divider/combiner 430 is a passive device that couples a defined amount of the electromagnetic power in a transmission line to a port that enables the signal to be used by another circuit. For example, in one implementation, an electronic signal may be received from a repeater along wire 450 that is divided in such a way that 25% of the signal is sent to an external device along wire 452 and 75% of the signal is sent to duplexer 340 for transmission to OFA 112 in the manner already described. Alternatively, if the electronic current flows in the opposite direction, the two signals may be combined and sent to a repeater within the system.

Turning now to the method by which the radio communications system operates, FIG. 5 is a flow chart of example method 500 that is used in a PTC system for switching the signal transmission mode of the bi-directional amplifier. In PTC, a system of functional requirements is provided that serve to monitor and control train movements in order to provide increased railway safety. Therein, information in the form of movement authorities may be received about a train's location within the railway network and where the train may safely travel. Equipment on board may then enforce the safe travel by preventing unsafe movements. Voice and data communications play a central role in PTC systems. The system according to the present disclosure is designed to smoothly exchange communication signals (e.g., data and voice signals) into and out of the shielded tunnel environment.

At 502 method 500 includes monitoring RF signals incident on antenna 110 of OFA 112 to determine whether a pilot activation signal is present. In one instance, the pilot activation signal is a 468 MHz signal that adjusts the position of switches 220 and 222 within the off-air amplifier to switch the direction of signal transmission through the system. As previously described above, when no pilot signal is received, at 504, OFA 112 may be operated in a default mode, for example the uplink transmission mode, wherein data signals are transmitted from inside the tunnel to the antenna and beyond into the free air space outside of the tunnel. At 506, the method thus includes detecting the pilot activation signal. Then, based on whether a pilot signal is detected, the direction of signal flow through the system may be adjusted so the device and system operate in the second operating mode. For example, the second operating mode may be a downlink transmission mode. In other embodiments, it may be envisioned that the default mode is the downlink transmission mode and upon detecting a pilot signal, the direction of signal flow may be adjusted to the uplink transmission mode.

When both transmit signal direction and radio signal coding are present, in other words a secure encoded pilot signal that provides the logic for switching OFA 112, at 508, method 500 further includes switching the amplifier device to the downlink transmission mode. The sensing switch mechanism in the bi-directional amplifier may switch within 1 millisecond (ms) of receiving the example 468 MHz carrier signal in order to complete the radio path between the communication devices, otherwise, the controlled device may not sufficiently receive the signal sent from the control device. As such, at 510, the bi-directional amplifier may operate in a second mode to transmit data in the second direction after the switching of the device by the pilot activation signal as long as a pilot signal is detected. After completing the transmission sequence to transmit the data in the second direction, discontinuation of the pilot signal may switch the bi-directional amplifier back to the default mode while RF signals in the tunnel are monitored, as indicated at 512. Alternatively, if no pilot signal is detected at 506, method 500 continues operation of the OFA in the default uplink, or receive mode, wherein a signal occurring from a source within the tunnel or shielded zone is collected by the radiating cable or distributed antenna network, which is a network of spatially separated antenna nodes connected to a common source via a transport medium that provides wireless service within a shielded geographic area or structure. As noted already, the amplifier operates by default in an “at rest” condition with the signal flowing in the direction of arrow 204, illustrated in FIG. 2, when no pilot signal is received.

With respect to the speed of switching OFA 112 according to method 500, because the radio communications system according to the present disclosure allows for a wireless connection between base station 102 or a repeater located remotely from a tunnel, and the amplifier mounted near or at a tunnel entrance, switching the bi-directional amplifier may occur within a 1 ms time period. Therefore, in order for the railway communication system to achieve the high safety standards implemented for positive train control, the communication system of the present disclosure is designed to switch bi-directional OFA 112 quickly between operating modes. As such, exciter unit 120 may send an RF signal that reaches the tunnel within the mandated time period such that OFA 112 receives the signal and adjusts the position of one or more switches within the circuit to change the direction of signal communication within. For example, the mandated time period may be a within a threshold time period wherein the threshold time period is 1 ms. Because this can be done remotely as described above, a single base station may be equipped to monitor and communicate with multiple tunnels in parallel by sending one or more wireless RF signals to bi-directional amplifiers associated with each shielded area (e.g., indicated at 130A, 130B, and 130C of FIG. 1). For instance, in one implementation, base station 102 may be located on a hill in view of multiple tunnel entrances and configured for radio communication into each tunnel. In another implementation, base station 102 may be in view of a first tunnel entrance but obstructed from other tunnels, for instance, due to a mountainous geographical terrain of the surrounding areas. In such a case, the bi-directional radio communications system may still operate as described but rely on surface extension schemes that are described below with respect to FIGS. 6 and 7.

Thus, in some embodiments, a method for communicating into one or more shielded areas, is disclosed including operating a bi-directional amplifier in an uplink transmission mode wherein RF signals are transmitted out of the shielded area when no pilot signal is detected, adjusting a pilot controlled mode switching element to operate the bi-directional amplifier in a downlink transmission mode when a pilot signal is detected, and transmitting RF signals into the shielded area when the bi-directional amplifier operates in the downlink transmission mode.

It should be appreciated that in one non-limiting example, the method further may include adjusting the pilot controlled mode switching element within a threshold period of time. Further, in some examples, the uplink transmission mode transmits RF signals from the shielded area to a transmission device, and a downlink transmission mode transmits RF signals from the transmission device to the shielded area. The transmitted RF signals may include one or more of data and voice signals. Further, the communication may be simplex, half-duplex or other suitable communication method.

Turning now in more detail to FIGS. 6 and 7, these figures show example propagation diagrams for extending the range of coverage beyond the tunnel environment using the methods already described. Although the examples shown may also be implemented in the manner described above, wherein an off-air amplifier is switched based on an exciter unit mounted at a base station, the system may also be configured for switching based on a signal received from a DP repeater. For this reason, examples in FIGS. 6 and 7 show a DP repeater for switching the direction of signal transmission, which then carries the signal received to one or more shielded areas using bi-directional amplifiers and non-radiating cables, radiating cables, and/or an antenna network.

FIG. 6 shows a system layout for extending a tunnel radio link system from the amplified end of one tunnel radio system to another tunnel or shaded zone wirelessly using an OFA. Therein, DP repeater 610 is located at the head end of the system and is shown mounted at the entrance of first tunnel 110A. Bi-directional in-line amplifiers shown at 612 are also included and spaced along radiating cable 114 to provide an amplification of the RF signal carried therein. As described above, the in-line amplifiers provide for signal boosting along the length of the tunnel. Inclusion of in-line amplifiers may be especially useful in longer tunnels where the signal may be boosted in the tunnel and thereby counteract radiating losses along the length of the cable. Although the examples described include in-line amplifiers, it is possible to implement the system described without in-line amplifiers. For example, in shorter tunnels no signal amplification may be used whereas in longer tunnels (e.g., signals transmitted distances greater than a half mile) in-line amplifiers may be included to amplify signals along the length of the tunnel, which in general, depends on the distance or length the signal is to be carried. In other words, the number of in-line amplifiers included depends on the length of tunnel transmission in addition to other factors. At the end of first tunnel 110A, exciter unit 614 that is shown as an exciter device and antenna for simplicity may communicate with second tunnel 110B connected by railroad tracks 620 through wireless communication by exchanging transmission signals 604 with an OFA unit as described above with respect to the radio communications systems of FIGS. 1 and 2A-2D. As also described above, transmission signal 604 may be sent in either direction depending on the transmission mode of the off-air amplifier. In addition to the programmable link module, in this configuration, exciter unit 614 may include a bi-directional amplifier that enables integration into a system on the end of an amplifier run for increased surface coverage. Therefore, exciter unit 614 may receive commands from amplifiers on the uplink side of the system. For example, when DP repeater 610 switches to the TX mode, the head end may signal all of the amplifiers including the amplifier in exciter unit 614 so that they are all synchronized to the DP repeater operation in the manner described above with respect to the switching of OFA 112.

OFA 616 is mounted at the entrance of second tunnel 110B to transmit radio communication signals (e.g., data and voice signals) into and out of the second tunnel via radiating cable 114. As is also indicated in the figure, the first 100 feet of cable leading into the tunnel may be comprised of non-radiating cable to provide isolation from the surface capture antenna. After this point, the cable is of the radiating type for the length of the tunnel. Therefore, in some embodiments, the radiating coaxial cable may include sections comprised of non-radiating cables.

In FIG. 7, an OFA is used together with an amplifier/antenna system for extending surface coverage beyond a tunnel environment and around a shielded area, for example, an area blocked by one or more mountains indicated at 708. This embodiment is similar to the embodiment described above with respect to FIGS. 1 and 2A-2D except a non-radiating cable may be used to connect first antenna 730, second antenna 732, and third antenna 734 in antenna network 714 whose inclusion serves to radiate the signal to mobile communication devices in the otherwise shielded area. As described in FIG. 6 above, the head end includes a DP repeater 710 that sends a signal into the tunnel. Elements which are similarly numbered correspond to the elements described in FIG. 6 and will not be described again for brevity. At the end of the tunnel, exciter unit 712 communicates with OFA 720 through first transmission signal 704. Although OFA 720 is not mounted at the entrance of a tunnel as was described in relation to FIGS. 1 and 2A-2D, the unit may be positioned so as to extend the surface signal to the area otherwise shielded by mountain 708. Because the scene represented in FIG. 7 may represent a long distance (e.g. greater than a mile), two bi-directional in-line amplifiers 722 are shown that boost the signal in order to counteract power losses incurred along the signaling pathway. The system is also shown having splitter 724 that further splits the transmitted signal in two directions so a portion of the signal is sent to second antenna 732 and a part of the signal is sent to third antenna 734. Third antenna 734 may further transmit second transmission signal 706 to the shielded area on the backside of mountain 708. For simplicity, only the transmission signals emitted from the tunnel into antenna network 714 and from the third antenna 734 to the shielded area are shown although first antenna 730 and second antenna 732 may also emit signals for detection by mobile devices.

Turning to a description of the radio communication system according to the second embodiment, FIG. 8 shows a propagation diagram of the communications system comprising communication using two antennas. While the first embodiment describes a system that uses a transmitter that keys in response to base station keying, in some instances, such a configuration may cause a delay in signal propagation (e.g., >10-20 ms). However, signal propagation within 1-3 ms is desirable. For this reason, the first embodiment may be used with a DP/EOT system that allows for longer switch times (e.g., greater than 50 ms) in some instances. Alternatively, the second embodiment achieves high-speed communication optimized for use in a PTC system. A radio communication system configured with two antennas allows for a transmitter to be on and transmitting substantially all of the time (e.g., 100% of the time) while signals are transmitted to the train from the base station. With this arrangement, the pilot signal may occur along a separate line such that it does not interfere with train operation or track/traffic management. A system configured according to the second embodiment allows for switching within the millisecond time frame, and so is compliant with PTC type digital transmitters that are becoming increasingly present.

As noted above, the radio frequency communication system according to the second embodiment includes two antennas. Thus, the system may be configured to continually transmit a signal from base transceiver 812 at base station 802 via first antenna 810A while second antenna 820A sends a pilot signal from exciter 822 to adjust the direction of signal transmission from the second antenna based on the operating mode of the communications system. In this way, high-speed communications may occur in the manner already described while the system transmits and/or receives data signals continually. In some embodiments, base station 802 may be configured to communicate into the tunnel via OFA 804. For example, first antenna 810A may operate on a known PTC channel (e.g., at 220.1375 MHz, 220.4125 MHz, etc.) to communicate with first antenna 810B located at a tunnel entrance via data signal 816 while exciter 822 emits UHF signals 826 that are detected at the tunnel entrance via second antenna 820B. In this way, the system allows for simultaneous communication while transmitting and/or receiving data.

FIG. 9A shows an example block diagram of the communications system of FIG. 8 in greater detail whereas FIG. 9B shows a block diagram of exciter unit 822 and FIG. 9C shows an example block diagram of OFA 804. Because the radio communications system according to the second embodiment may be configured with a transmitter that is powered on substantially always (e.g., 100% of the time), the system further includes a digital attenuator in-line between the antenna and physical transmitter section in the exciter unit that is connected to the base transmitter. Thereby, the switching time may occur ultrafast, e.g., within the millisecond (ms) time frame, in order to comply with standards based on PTC type digital transmitters.

Base station 802 may be configured with two antennas, therefore base station 802 may further comprise computer 814 that communicates with transceiver 812 and exciter 822 that are also electrically coupled. Transceiver 812 is separate from exciter 822 and configured to transmit and receive electrical signals such as voice or data signals via first antenna 810A. Conversely, exciter 822 is configured to transmit signals via second antenna 820A. As one example, first antenna 810A may transmit and receive at 220 MHz while second antenna 820A transmits the pilot signal at 468 MHz. As noted above, OFA 804 is also configured with two antennas 810B and 820B that are configured to receive signals transmitted. For simplicity, first antenna 810A may transmit and receive signals while second antenna 820B receives the pilot signal used to control the direction of signal transmission. With this arrangement, transceiver 812 located at the base station may synchronously transmit and receive signals based on the direction of transmission via a pilot signal as described above with regard to FIG. 5.

FIG. 9B shows a block diagram of exciter 822 in greater detail while FIG. 9C shows a block diagram of OFA 804 in greater detail. Exciter 822 may be installed at the site of transceiver 812. The exciter generates a coded signal that is used to synchronize OFA 804 with donor data from the transceiver. As one example, exciter 822 may incorporate a UHF programmable transmitter with an isolation module. The exciter is interconnected to transceiver 812 for synchronous transmission of activation data for OFA 804. OFA 804 may receive the UHF signal transmitted via a UHF antenna that is referred to herein as second antenna 820B. Alternatively, bi-directional signal transmission may occur via the PTC antenna, where the switchable direction of signal transmission is based upon a pilot signal received by the UHF antenna.

The present description may provide several improvements. In one example, the approaches may be used for remotely communicating with mobile devices in a shielded environment. In the embodiments described, the shielded area is a tunnel within the railway network, however, other shielded areas are also possible (e.g., a mine, the basement of a building, etc.). In addition, the bi-directional amplifier operates in a default receiving mode but can be quickly switched to the transmission mode based on detection of a pilot activation signal. Such a design may allow data transmission to be timed to coincide with the switching of the bi-directional amplifier so substantially no data is lost during transmission. For this reason, the switching of the bi-directional amplifier to a second operating mode is described herein as occurring within a threshold time period to allow communication in a simplex or half-duplex mode, which is the communicating method traditionally used by the railroad industry.

It should be appreciated that the system and method described herein may be applied in a number of environments, including, but not limited to mines, oil platforms, industrial surface complexes, such as petroleum refineries, ships, etc. The system may be utilized in shielded environments where communication may be limited during passage, such as for example the train tunnels described herein. However, the system may further be applied in other similar environments.

This concludes the description. The reading of it by those skilled in the art would bring to mind many alterations and modifications without departing from the spirit and the scope of the description. It is to be understood that the configurations and/or approaches described herein are exemplary in nature, and that these specific embodiments or examples are not to be considered in a limiting sense, because numerous variations are possible. The specific routines or methods described may represent one or more of any number of signal transmission strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A radio frequency communication device, comprising:
an antenna for sending and receiving RF signals, and
a bi-directional amplifier configured to transmit RF signals over a single pathway, the RF signals transmitted at least partially through a shielded area, wherein the bi-directional amplifier unit comprises:
a processor for adjusting a signal transmission direction based on detection of a pilot activation signal,
a pilot controlled mode switching element for switching the device between two operating modes based on detection of the pilot activation signal, the two operating modes comprising:
an uplink transmission mode wherein RF signals are transmitted in a first direction, wherein the uplink transmission mode is a default mode when the pilot activation signal is not detected, and
a downlink transmission mode wherein RF signals are transmitted in a second direction.

2. The radio frequency communication device of claim 1, wherein the device includes one of: a steel case for enclosing one or more electrical components and a mounting rack for attaching one or more electrical components.

3. The radio frequency communication device of claim 1, wherein the device is coupled to a radiating transmission line to allow communication into the shielded area.

4. The radio frequency communication device of claim 3, wherein the device is coupled to a second transmitting device configured to send RF signals into the shielded area via the bi-directional amplifier.

5. The second transmitting device of claim 4, wherein the second transmitting device is further configured to transmit the pilot activation to switch operating modes of the radio frequency communication device.

6. The radio frequency communication device of claim 1, wherein RF signals in the first direction are transmitted from the shielded area to the second transmitting device, and wherein the device is switched to transmit RF signals in a second direction from the second transmitting device to the shielded area.

7. The radio frequency communication device of claim 6, wherein switching the device occurs within a threshold time period.

8. The radio frequency communication device of claim 7, wherein the threshold time period is 1 millisecond.

9. The radio frequency communication device of claim 3, wherein the shielded area is a tunnel.

10. A communication system, comprising:
a transmission device for wirelessly sending RF signals into one or more shielded areas via a bi-directional amplifier coupled to a radiating transmission line,
a bi-directional amplifier configured to transmit RF signals in two directions over a single pathway based on detection of a wireless pilot activation signal received from the transmission device, and
the radiating transmission line coupled to the bi-directional amplifier disposed along the length of the shielded area.

11. The communication system of claim 10, wherein the transmission device is located at one of: a base station on a first tunnel side, a distributed power repeater on a first tunnel side, and a second tunnel side opposite the distributed power repeater.

12. The communication system of claim 10, wherein the bi-directional amplifier includes a processor for transmitting RF signals in two directions along a single pathway, and a pilot controlled switching element for switching the bi-directional amplifier between two operating modes within a threshold time period, the threshold time period further being 1 millisecond.

13. The communication system of claim 10, wherein the two operating modes include an uplink transmission mode that transmits RF signals from the shielded area to the transmission device, and a downlink transmission mode that transmits RF signals from the transmission device to the shielded area.

14. The communication system of claim 11, wherein a transmission device is located at a second tunnel side to communicate beyond a tunnel into a second shielded area by exchanging signals with a bi-directional amplifier coupled thereto.

15. The communication system of claim 14, wherein wirelessly communicating beyond the shielded area includes transmitting signals via an antenna network.

16. A method for communicating into one or more shielded areas, comprising:
operating a bi-directional amplifier in an uplink transmission mode wherein RF signals are transmitted out of the shielded area when no pilot signal is detected,
adjusting a pilot controlled mode switching element to operate the bi-directional amplifier in a downlink transmission mode when a pilot signal is detected, and
transmitting RF signals into the shielded area when the bi-directional amplifier operates in the downlink transmission mode.

17. The method of claim 16, wherein adjusting the pilot controlled mode switching element is within a threshold period of time.

18. The method of claim 16, wherein the uplink transmission mode transmits RF signals from the shielded area to a transmission device, and a downlink transmission mode transmits RF signals from the transmission device to the shielded area.

19. The method of claim 18, wherein transmitted RF signals are data and voice signals.

20. The method of claim 19, wherein communication is one of: simplex and half-duplex.
